(19) United States
(12) Patent Application Publication
(10) Pub. No.: US 2026/0313281 A1
(43) Pub. Date: Oct. 8, 2026

(54) Audio Headset with Fabric Outer Layer

(71) Applicant: Bose Corporation, Framingham, MA (US)

(72) Inventors: Alexander Scott Irwin, Belmont, MA (US); Masanori Honda, Northborough, MA (US); Jonathan Alexander Knudsen, Providence, RI (US)

(21) Appl. No.: 19/172,961

(22) Filed: Apr. 8, 2025

(51) Int. Cl. H04R 1/10

(52) U.S. Cl. CPC H04R 1/1008; H04R 1/105; H04R 1/1058; H04R 2201/105

(57) ABSTRACT

Various implementations include earphones, earphone cushions and related headsets. In some aspects, an audio earphone includes: a fabric outer layer; an elastomer layer under the fabric outer layer and directly bonded to the fabric outer layer; and a cushion material under the elastomer layer.

### TECHNICAL FIELD

This disclosure generally relates to headsets. More particularly, the disclosure relates to audio headsets including earphone cushions, headbands, and related headsets.

### BACKGROUND

Headphones can include materials for softening the contact of the headphones against the user's ear (a supra-aural design) or against portions of the user's head adjacent to the user's ears (a circum-aural design). The materials are intended to provide comfort to the user as the headphones are used, and may reduce the amount of external noise reaching the user's ear and/or may absorb noise such as audio rendered by an audio driver of the headphones that is reflected from a portion of the user's ear or head, or any reverberant sound wave within the ear cushion plenum. These materials may be formed into what is referred to herein as earphone cushions, or ear cushions. Additionally, these materials may be applied to headband cushions. However, certain conventional cushion materials suffer from one or more deficiencies.

### SUMMARY

All examples and features mentioned below can be combined in any technically possible way.

Various implementations include headsets, earphones, earphone cushions, headbands, and related headsets. In some particular aspects, an audio headset includes: a fabric outer layer; an elastomer layer under the fabric outer layer and directly bonded to the fabric outer layer; and a cushion material under the elastomer layer.

Additional implementations include an audio headset having: a fabric outer layer; an elastomer layer under the fabric outer layer; and a cushion material under the elastomer layer, the cushion material including a silicone gel.

Additional implementations include a method of forming an audio headset including at least one of an earphone or a headband, the method including: applying a cover to a silicone gel cushion material, the cover including a fabric outer layer and an elastomer layer inner layer; and attaching the covered cushion material to an earphone frame.

Implementations may include one of the following features, or any combination thereof.

In some cases, the elastomer layer includes a synthetic leather.

In certain cases, the synthetic leather includes polyurethane (PU).

In some cases, the synthetic leather includes silicone.

In some cases, the cushion material includes a silicone gel.

In some cases, the elastomer layer has a thickness of approximately 50 micrometers (um) to approximately 1,000 um.

In some case, the elastomer layer has an approximately uniform thickness around the earphone.

In some cases, the fabric outer layer has an exterior finish. In some examples, the exterior finish includes a coating. In further examples, the exterior finish includes a woven fabric finish, a knitted fabric finish, etc. In particular examples, the exterior finish can be tailored for a user or group of users based on criteria including aesthetics, comfort, breathability, and/or durability.

In some cases, the fabric outer layer forms a cover that has multiple fabric pieces.

In some cases, a portion of an interior of the fabric outer layer is free of the elastomer layer, thereby providing acoustic passages through the audio earphone.

In some cases, the bonded fabric outer layer and elastomer layer is die cut and wrapped around the cushion.

In some cases, the elastomer layer is directly bonded to the fabric outer layer.

In some cases, the fabric outer layer is part of an earphone and/or a headband in the audio headset.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

FIG. 1 is perspective view of a headset including a headband and a set of earphones according to various implementations.

FIG. 2 is a cross-sectional view of a portion of an earphone cushion in an earphone of FIG. 1, according to various implementations.

FIG. 3 illustrates an earphone cushion cover before it is spread around an earphone cushion, according to various implementations.

FIG. 4 is a cross-sectional view of a portion of a headband cushion in an audio headset according to various implementations.

FIG. 5 shows an example graph illustrating testing results for passive insertion gain (PIG) for a conventional PU leather outer cover and a conventional fabric outer cover, as compared with an audio headset according to various implementations.

FIG. 6 shows example differential graphs of PIG for a fabric outer cover and an audio headset according to various implementations, as compared with a conventional PU leather outer cover.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that a cover for an earphone cushion and/or headband can be formed of a breathable, durable fabric without compromising acoustic performance. In particular cases, an audio headset (e.g., including an earphone and/or headband) includes a fabric outer layer, an elastomer layer under the fabric layer, and a cushion material under the elastomer layer. In certain of these cases, the elastomer layer is directly bonded to the fabric outer layer. In additional cases, an audio headset (e.g., including an earphone and/or headband) includes a fabric outer layer, an elastomer layer under the fabric outer layer, and a cushion material under the elastomer layer. In certain of these cases, the cushion material includes a silicone gel.

In further cases, a method of forming an audio headset including an earphone and/or a headband includes i) applying a cover to a silicone gel cushion material, where the cover includes a fabric outer layer and an inner elastomer layer, and ii) attaching the covered cushion material to an earphone frame. In certain of these cases, the fabric outer layer is directly bonded to the inner elastomer layer.

As noted herein, certain conventional headbands and/or ear cushions include a leather or polyurethane (PU) leather outer layer that contacts the skin of the user (e.g., on or around the ear). While leather or PU leather can provide acoustic benefits, it may cause user discomfort, e.g., lacking breathability and/or trapping humidity against the skin. Further, such leather or PU leather outer layers can wear down over time, cracking and/or flaking, causing discomfort or otherwise looking unsightly. Certain other conventional ear cushions employ a fabric outer layer that contacts the skin of the user and address some shortcomings of leather or PU leather outer layers. However, those fabric ear cushions can hinder acoustic performance. Previous attempts to use a fabric outer layer on ear cushions have required additional reinforcement under the cover (e.g., a firm inner tube) to avoid degradation of acoustic performance. However, these additional reinforcements may cause user discomfort. Additionally, previous attempts to use a fabric outer layer on ear cushions have relied on specialized equipment, high-complexity molds, and/or custom knit stock, leading to increased complexity and cost in manufacture. Further, use of PU leather on other portions of audio headsets (e.g., headbands) may lead to similar issues with comfort, durability, and/or wear as identified relative to earphones.

In contrast to these conventional approaches, certain implementations include audio headsets including an earphone and/or headband that has a fabric outer layer providing enhanced user comfort without sacrificing acoustic performance. Some particular examples include an elastomer layer directly bonded to a fabric outer layer, also called a “fabric-leather” layer. Additional implementations include a silicone gel cushion material under the elastomer layer. The fabric outer layer can provide enhanced comfort and/or durability relative to earphones with distinct types of outer layer, without sacrificing acoustic performance.

Various benefits of the fabric outer layer directly bonded to the elastomer are described herein. For example, the elastomer enhances acoustic performance, e.g., relative to a fabric-only layer. Further, the fabric outer layer can provide acoustic (e.g., functional) benefits comparable to conventional PU-leather that includes ventilation holes. Additionally, the fabric-leather layer can be applied to various surfaces on a headset, acting for example as an inherent barrier to external contaminants such as humidity, ultraviolet light, perspiration, sebum, etc., without degrading the internal cushion material. Further, the fabric-leather layer and headsets disclosed herein can beneficially provide enhanced breathability and comfort. Additionally, the fabric-leather layer can enable distinct, and in some cases, simplified assembly approaches relative to certain conventional headsets. For example, the use of the fabric-leather layer can enable use of die-cutting and thermoforming in assembling earphone cushions and/or headband cushions, without the need for custom fabric knits, custom molded barriers, etc. Further, the fabric-leather layer allows for use of liquid silicone rubber (LSR) as a cushion material, which is not possible in certain conventional headsets. These and other benefits will become apparent through the accompanying FIGURES and descriptions.

Commonly labeled components in the FIGURES are considered to be substantially equivalent components for the purposes of illustration, and redundant discussion of those components is omitted for clarity. Numerical ranges and values described according to various implementations are merely examples of such ranges and values, and are not intended to be limiting of those implementations. In some cases, the term “approximately” is used to modify values, and in these cases, can refer to that value +/- a margin of error, such as a measurement error, which may range from up to 1-5 percent.

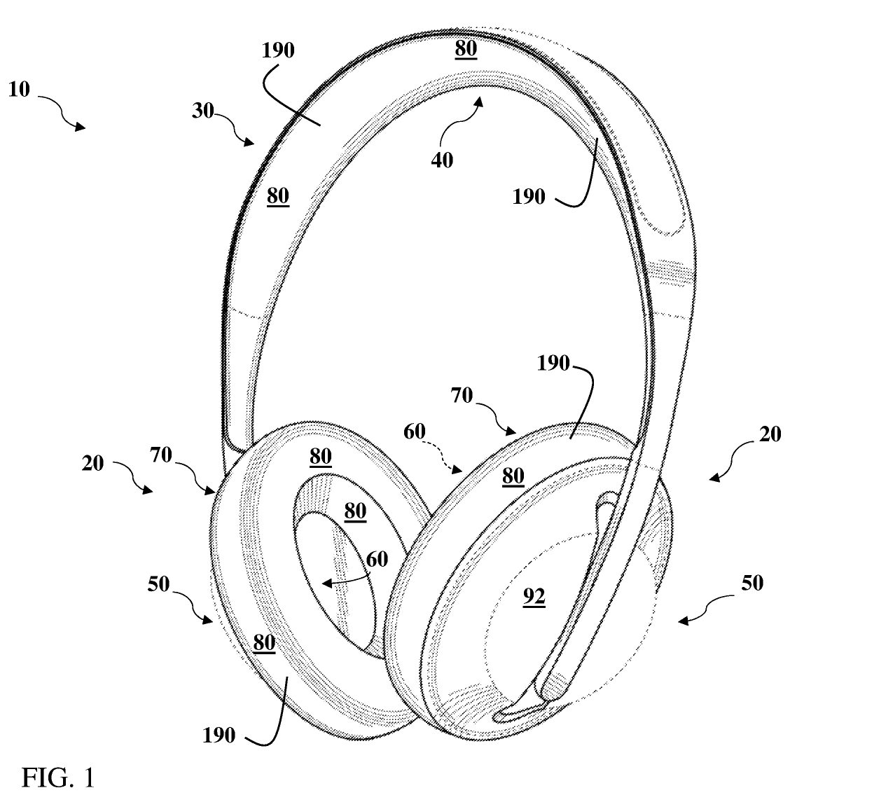

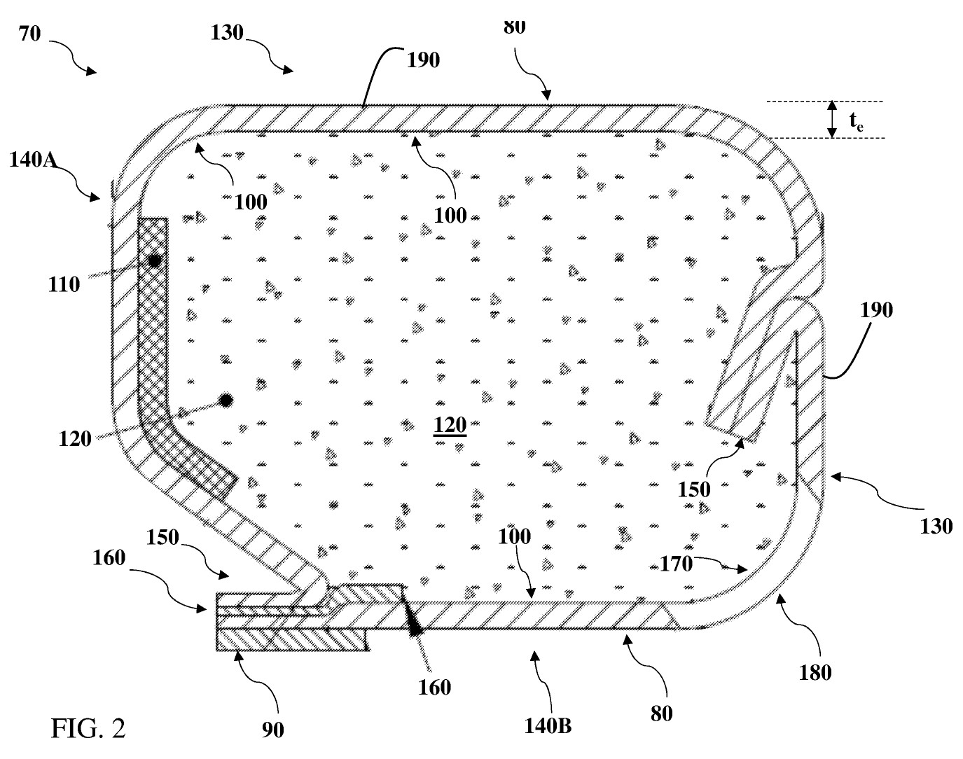

FIG. 1 depicts an audio device, including a headset 10 according to various implementations. FIG. 2 shows a close-up perspective of a portion of the headset 10 in FIG. 1. These FIGURES are referred to concurrently. In this example, the headset 10 is illustrated as a pair of around-ear headphones (also referred to as earphones). However, it is understood that principles of the disclosed implementations can be applied to on-ear headphones in various implementations. Headset 10 can include a pair of earpieces (or, earphones) 20 configured to fit over the ear, or on the ear, of a user. A headband 30 spans between the pair of earphones 20 and is configured to rest on the head of the user (e.g., spanning over the crown of the head or around the head). The headband 30 can include a head cushion 40 in some implementations. Stored within one or both of the earphones 20 are electronics and other components for controlling audio output at the headset 10 (not shown).

Each earphone 20 can include an earcup 50 having a front opening 60 (one visible in this view) configured to be adjacent to an ear of a user when worn by the user. Each earphone 20 also includes an earphone cushion (or simply, cushion) 70 sized to secure to the front opening 60 of the earcup 50. In various implementations, the earphone cushion 70 is configured to surround a user’s ear (e.g., a circum-aural design) during use of the headset 10, e.g., to contact a portion of the user’s head adjacent to the ear. However, in other implementations, the earphone cushion 70 can be configured to rest on at least a portion of the user’s ear (e.g., a supra-aural design). Additional details of earphone construction are described and illustrated for example in US Patent No. 8,374,373 (High Transmission Loss Headphone Cushion, issued February 12, 2013); and PCT (WO) Application No. PCT/US2022/019245 (Earphone Cushion with Mechanically Grounded Cover), and corresponding US Patent Application No. 18/280,034 (Earphone cushion with cover fixed to rigid component to mitigate vibration of the cover, filed March 8, 2022), the entire contents of each of which are hereby incorporated by reference.

FIG. 1 also shows the earphone 20 having a fabric outer layer 80 that is configured to contact the user’s ear and/or the area around the user’s ear. In further examples, head cushion 40 can include a fabric outer layer 80 configured to contact the crown region of the user’s head as depicted in FIG. 1. In further implementations, the earphone 20 and/or the head cushion 40 include fabric outer layer 80.

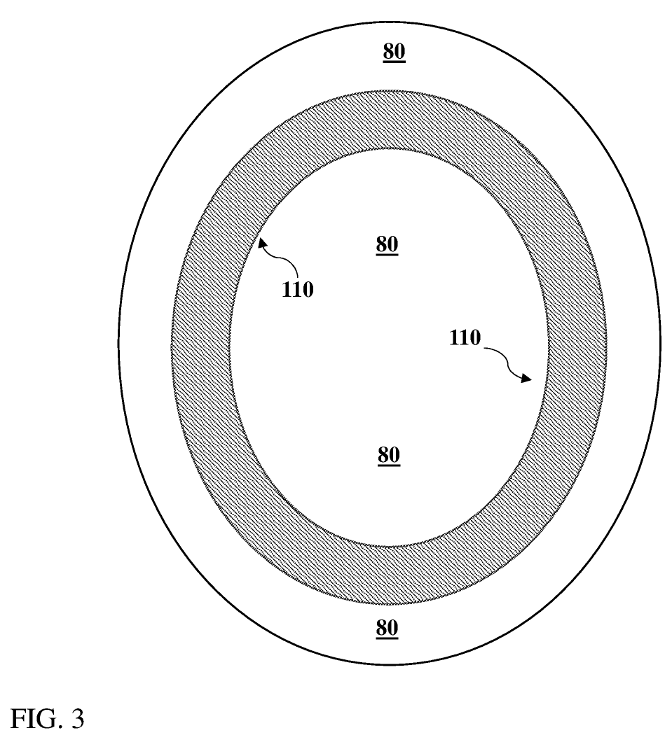

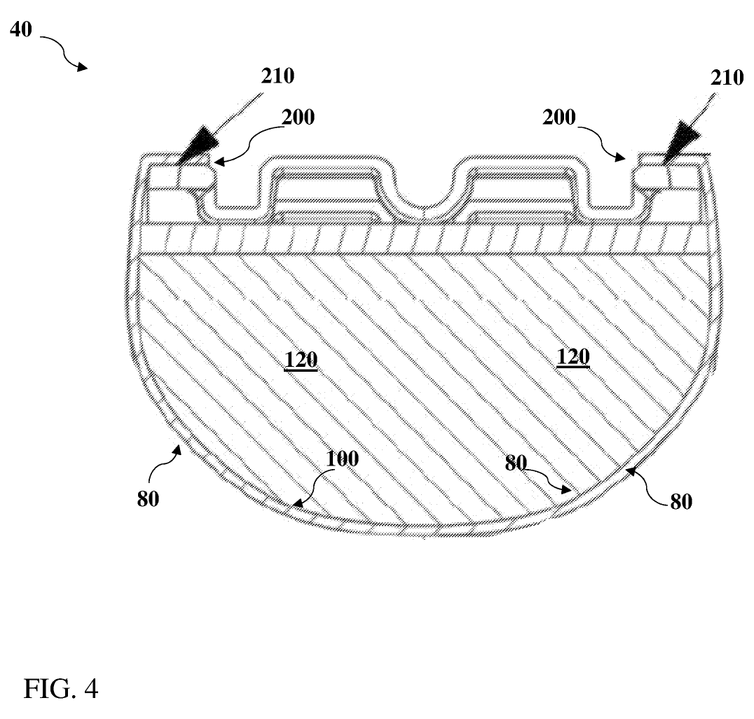

FIG. 2 shows a sectional view of the earphone cushion 70 connected with a gasket 90 according to various implementations. Gasket 90 can be part of a fixture connecting the cushion 70 with the rigid cover 92 of the earcup 50 (FIG. 1), e.g., via one or more complementary connectors as described in US Patent No. 8,374,373 and US Patent Application No. 18/280,034 (previously incorporated by reference herein). FIG. 3 shows an earphone cushion cover before it is spread around an earphone cushion 70 according to various implementations. FIG. 4 shows an example of a section through head cushion 40 according to various implementations.

With reference to FIGS. 1-4 and particular reference to FIG. 2, in various implementations, a head cushion 40 and/or earphone cushion 70 includes fabric outer layer 80, an elastomer layer 100 under the fabric outer layer 80, and a cushion material 110 under the elastomer layer 100. In particular cases, a core cushion (or bulk cushion) 120 is placed under the cushion material 110.

In some aspects, the fabric outer layer 80 includes a cloth such as a cloth formed from rayon and/or nylon. In a particular example, the fabric outer layer 80 is approximately 80 percent rayon and approximately 20 percent nylon. In further examples, the fabric outer layer 80 is woven or knit, and can enable tailoring and/or customization as further described herein.

In certain implementations, as noted herein, the elastomer layer 100 is directly bonded to the fabric outer layer 80. In some examples, a solvent based wet coating process can be used to directly bond the fabric outer layer 80 to elastomer layer 100, including for example: (i) a fabric layer (e.g., fabric layer 80) can be rolled (e.g., from a spool), (ii) a wet PU resin (e.g., elastomer layer 100) can be directly coated over the fabric layer, (iii) the coated fabric layer is submerged in a solution (e.g., water-DMF solution) such that DMF escapes from the coated fabric to coagulate the coated layer, (iv) the coated, coagulated fabric layer is washed (e.g., in a cleaning solution) to remove solvents, and (v) the resulting coated fabric layer is wound and dried for application, e.g., as an outer layer in an audio headset such as in earphone cushions and/or headband cushions. In these cases, no intervening layer is positioned between the elastomer layer 100 and the fabric outer layer 80.

In another implementation, the elastomer layer 100 is directly bonded to fabric outer layer 80 in a dry lamination process. The dry lamination process can include: (a) coating a dry-type elastomer (e.g., PU or silicone) resin over a release paper (e.g., paper with embossed pattern and coated surface) and passing through a set of (e.g., oven) chambers, (b) repeating process (a) to build functional layers, such as an elastomer skin and foam, (c) applying (e.g., coating) an elastomer adhesive (e.g., PU adhesive or silicone adhesive) on the coated paper, (d) rolling and attaching a substrate (e.g., a thermoplastic film or fabric) to the elastomer adhesive, (e) curing the adhesive in a chamber (e.g., oven chamber), and (f) separating the release paper as the synthetic leather (including elastomer layer and fabric outer layer) is wound onto a separate roll. In this process, the resulting elastomer layer 100 is directly bonded to the fabric outer layer 80 in the separated layer and can be applied, e.g., over cushion material 110 and/or core cushion 120. For example, the bonded elastomer layer 100 and outer layer 80 can be used as part of an outer layer in an audio headset such as in earphone cushions and/or headband cushions). In certain cases, the second coating (of elastomer adhesive) improves peeling strength of the finished material. In these cases, as described herein, no intervening layer is positioned between the elastomer layer 100 and the fabric outer layer 80.

In particular examples, the directly bonded fabric layer/elastomer layer 100 can be die cut and wrapped around the cushion material and/or the core cushion 120.

In particular implementations, the cushion material 110 includes a silicone gel. In additional implementations, the cushion material 110 includes liquid silicone rubber (LSR), polyurethane, and/or additional resin materials. In some examples, the cushion material 110 abuts the core cushion 120 such as a foam (e.g., urethane foam). In particular cases, the cushion material 110 is a relatively higher-density cushion than core cushion 120. The cushion material 110 may be positioned along less than an entirety of the interface between the inner surface of elastomer layer 100 and the outer surface of core cushion 120.

In some examples, the elastomer layer 100 includes polyurethane (PU) leather (e.g., a protein leather such as protein powder mix). In additional examples, the elastomer layer 100 includes silicone. In some cases, the elastomer layer 100 can have a thickness (tₑ) of approximately 50 micrometers (um) to approximately 1,000 um. In particular implementations, as illustrated in FIG. 2, the elastomer layer 100 has an approximately uniform thickness (tₑ) around the earphone. In particular cases, the fabric outer layer 80 forms a cover 130 that has multiple pieces 140A, 140B. In certain examples, two pieces 140A, 140B are bonded together at joints (or folds) 150. In one implementation, gasket 90 is connected with one of the joints 150, e.g., connecting the fabric outer layer 80 with rigid cover 92 (e.g., via a snap ring, complementary tabs/slots, etc.). A ring 160 (e.g., TPU ring) can be used to couple the fold 150 proximate the gasket 90 in some cases.

In some cases, e.g., as shown relative to earphone cushion 70 in FIGS. 2 and 3, a portion of an interior 170 of the fabric outer layer 80 is free of the elastomer layer 100, thereby providing acoustic passages 180 through the cushion, e.g., through the earphone. These acoustic passages 180 can provide beneficial acoustic performance features such as described in US Patent Application No. 18/280,034 (previously incorporated by reference herein).

In some cases, the fabric outer layer 80 has an exterior finish 190 that can enable, among other things, customization of material feel, color, styling, etc. The exterior finish 190 can facilitate customization (or tailoring) for aesthetics, comfort, breathability, and/or durability. In a particular example, the color and/or styling of the finish on fabric outer layer 80 can be customized.

In certain cases, e.g., where the fabric outer layer 80 is used on a portion of the headband cushion 40 (FIGS. 1 and 4), the fabric outer layer 80 with underlying elastomer layer 100 may be additionally wrapped around a rigid coupler 200 for the headband 30 and adhered or otherwise connected to that rigid coupler 200 (FIG. 4), e.g., wrapped around one or more couplers 200 that connect the cushion 40 to the headband backing (or outer section). In some cases, an adhesive 210 is applied on an inner surface of the elastomer layer 100 to adhere the elastomer layer 100 to the coupler 200. In certain cases, the headband cushion 40 does not include additional cushion material 110 between the elastomer layer 100 and the core cushion 120. In other cases, at least a portion of the headband cushion 40 includes the cushion material 110 interposed between the elastomer layer 100 and core cushion 120.

Additional implementations include approaches for forming an audio headset including an earphone and/or headband cushion. In some of these cases, approaches include: (I) applying a cover to a silicone gel cushion material (e.g., cushion material 110, which overlies core cushion 120), the cover including a fabric outer layer 80 and an elastomer layer 110 inner layer; and (II) attaching the covered cushion material to an earphone frame. As noted herein, the fabric outer layer 80 is directly bonded to the elastomer layer 110 inner layer.

The various disclosed implementations can provide benefits relative to conventional audio headsets, for example, providing enhanced comfort, breathability, and/or durability relative to conventional headphones. The various disclosed implementations can also provide beneficial customization and/or tailoring for particular user tastes, in contrast to many conventional headphones. Further, relative to conventional fabric-outer audio devices, various disclosed implementations can be easier and/or less costly to manufacture, for example, requiring less specialized equipment and/or investment in custom molding equipment and specific knit stock.

One or more components in the electronic devices described herein can be formed of any conventional electronic device material, e.g., a heavy plastic, metal (e.g., aluminum, or alloys such as alloys of aluminum), composite material, etc. It is understood that the relative proportions, sizes and shapes of the transducer(s) and components and features thereof as shown in the FIGURES included herein can be merely illustrative of such physical attributes of these components. That is, these proportions, shapes and sizes can be modified according to various implementations to fit a variety of products.

### Example Testing Results

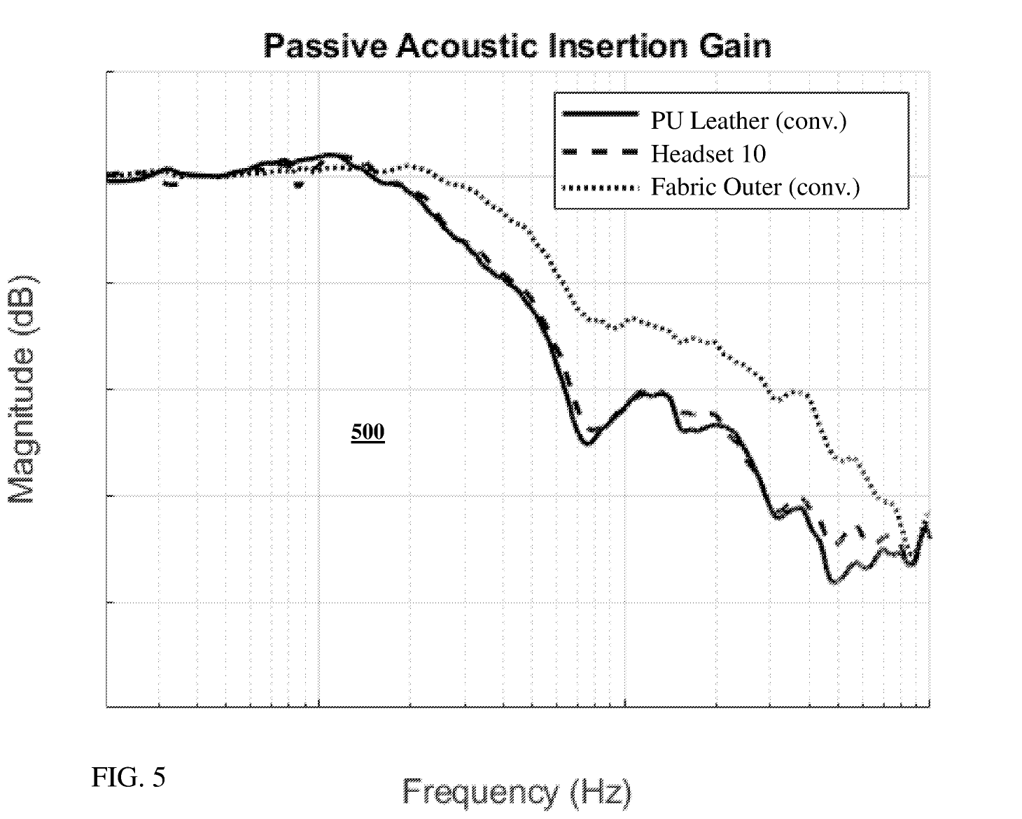

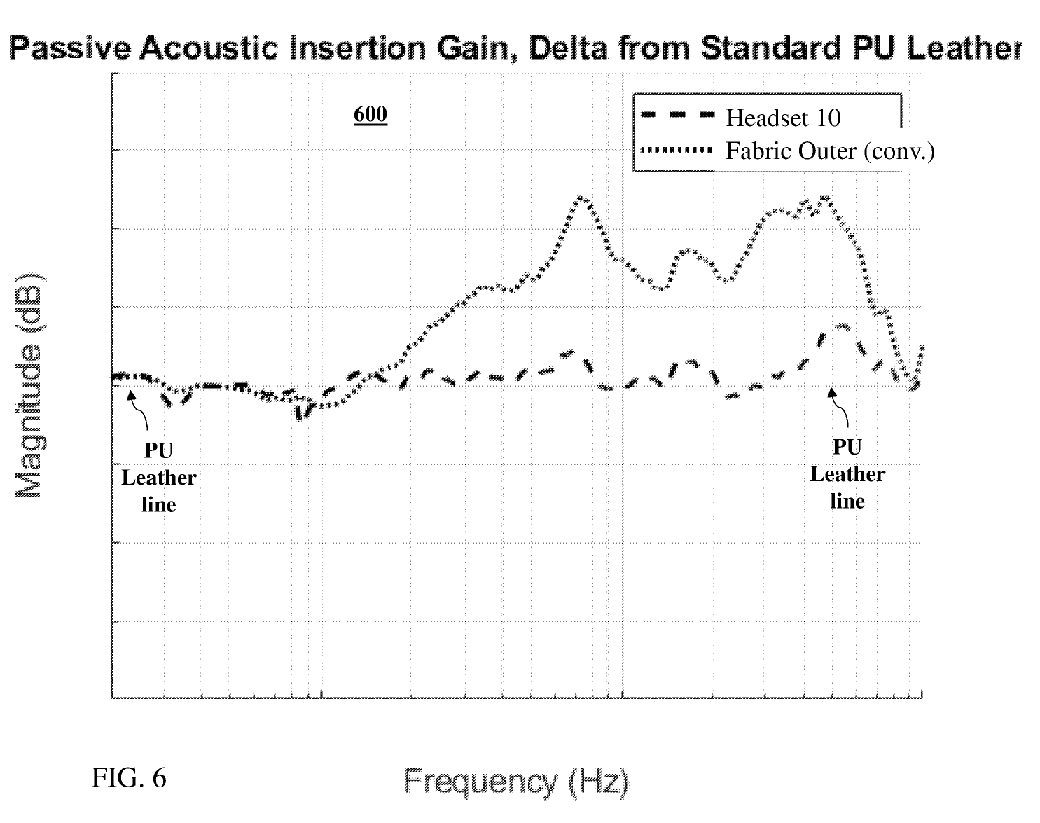

In some cases, headset 10 provides acoustic benefits relative to conventional headsets, for example, relative to conventional headsets with PU leather outer layers, and conventional headsets with fabric outer layers. In some cases, acoustic benefits can be characterized by passive (acoustic) insertion gain (PIG) and/or transmission loss. FIG. 5 shows an example graph 500 illustrating testing results for (PIG), in terms of magnitude (dB) v. frequency (Hz), for headset 10 compared with a conventional (conv.) PU leather outer cover (solid line) and a conventional (conv.) fabric outer cover (dot-dashed line). FIG. 6 shows example differential graphs of PIG for the headset 10 and the fabric outer cover, as compared with the conventional (conv.) PU leather outer cover. As shown in this example, headset 10 can provide comparable PIG to a conventional headset with a PU leather outer cover at relatively lower frequencies, while providing improvement in comfort, breathability, durability, customization and/or tailoring, as discussed herein.

In various implementations, components described as being “coupled” to one another can be joined along one or more interfaces. In some implementations, these interfaces can include junctions between distinct components, and in other cases, these interfaces can include a solidly and/or integrally formed interconnection. That is, in some cases, components that are “coupled” to one another can be simultaneously formed to define a single continuous member. However, in other implementations, these coupled components can be formed as separate members and be subsequently joined through known processes (e.g., soldering, fastening, ultrasonic welding, bonding).

A number of implementations have been described. Nevertheless, it will be understood that additional modifications may be made without departing from the scope of the inventive concepts described herein, and, accordingly, other implementations are within the scope of the following claims.

We claim:

1. An audio headset comprising:
a fabric outer layer;
an elastomer layer under the fabric outer layer and directly bonded to the fabric outer layer; and
a cushion material under the elastomer layer.

2. The audio headset of claim 1, wherein the elastomer layer includes polyurethane (PU) leather.

3. The audio headset of claim 1, wherein the elastomer layer includes silicone.

4. The audio headset of claim 1, wherein the cushion material includes a silicone gel.

5. The audio headset of claim 1, wherein the elastomer layer has a thickness of approximately 50 micrometers (um) to approximately 1,000 um.

6. The audio headset of claim 1, wherein the elastomer layer has an approximately uniform thickness around the earphone.

7. The audio headset of claim 1, wherein the fabric outer layer has an exterior finish.

8. The audio headset of claim 1, wherein the fabric outer layer forms a cover that has multiple fabric pieces.

9. The audio headset of claim 1, wherein a portion of an interior of the fabric outer layer is free of the elastomer layer, thereby providing acoustic passages through the audio earphone.

10. The audio headset of claim 1, wherein the fabric outer layer and bonded elastomer layer are die cut and wrapped around the cushion material.

11. The audio headset of claim 1, wherein the fabric outer layer is part of an earphone.

12. The audio headset of claim 1, wherein the fabric outer layer is part of a headband.

13. An audio headset comprising:
a fabric outer layer;
an elastomer layer under the fabric outer layer; and
a cushion material under the elastomer layer, the cushion material including a silicone gel.

14. The audio headset of claim 13, wherein the elastomer layer is directly bonded to the fabric outer layer.

15. The audio headset of claim 13, wherein the elastomer layer includes polyurethane (PU) leather.

16. The audio headset of claim 13, wherein the elastomer layer includes silicone.

17. The audio headset of claim 13, wherein the fabric outer layer is part of a headband and/or an earphone, and wherein the fabric outer layer has an exterior finish.

18. A method of forming at least one of an audio earphone or an audio headband, the method comprising:
applying a cover to a silicone gel cushion material, the cover including a fabric outer layer and an inner elastomer layer; and
attaching the covered cushion material to an earphone frame.

19. The method of claim 18, wherein the fabric outer layer is directly bonded to the inner elastomer layer, and wherein the inner elastomer layer includes polyurethane (PU) leather.

20. The method of claim 18, wherein the cover fabric outer layer is directly bonded to the inner elastomer layer with a dry lamination process or a solvent based wet coating process.
